(19) United States
(12) Patent Application Publication
(10) Pub. No.: US 2013/0241878 A1
(43) Pub. Date: Sep. 19, 2013

(54) TOUCH SENSOR WITH A MATRIX NETWORK OF CONDUCTIVE TRACKS AND TOUCH-CONTROL SCREEN

(71) Applicants: Pascal Joguet, Sadirac (FR); Guillaume Largillier, Bordeaux (FR); Julien Olivier, Bordeaux (FR)

(72) Inventors: Pascal Joguet, Sadirac (FR); Guillaume Largillier, Bordeaux (FR); Julien Olivier, Bordeaux (FR)

(73) Assignee: Stantum, Bordeaux (FR)

(21) Appl. No.: 13/989,982

(22) PCT Filed: Nov. 23, 2011
(86) PCT No.: PCT/FR2011/052734

§ 371 Date: May 28, 2013

(30) Foreign Application Priority Data
Nov. 26, 2010 (FR) 1004616

(51) Int. Cl. G06F 3/045

(52) U.S. Cl. CPC G06F 3/045
USPC 345/174

(57) ABSTRACT

A touch sensor including a tactile detection zone including a matrix array of conducting tracks constituting columns on a first insulating layer and rows on a second insulating layer, the first and second insulating layers being disposed opposite one another, and an array of conducting tracks configured to transfer electrical signals between the rows and columns of the matrix array and an interface connector for interfacing with a control system of the tactile sensor. The touch sensor further includes control circuits associated respectively with the rows and columns of the matrix array of conducting tracks, the array of conducting tracks extending between the control circuits and the interface connector.

The present invention concerns a touch sensor with a matrix network of conductive tracks.

It also concerns a touch-control screen implementing such a touch sensor.

In general terms, the present invention concerns the field of touch sensors, and in particular multi-contact touch sensors enabling simultaneous detection of several zones of contact with the touch sensor of an object, such as a stylus or a user's finger.

When this touch sensor is associated with a display screen, a touch-control screen is constituted making it possible, according to the elements displayed on the display screen (graphical objects, icons, images) to generate actions for controlling an item of software or equipment and/or for manipulating the displayed elements by taking into account the data acquired from the transparent touch sensor.

Such a touch sensor is known, which is described in particular in the document EP 1 719 047.

This touch sensor comprises a touch detection zone comprising a matrix network of conductive tracks constituting columns on a first insulating layer and rows on a second insulating layer.

These first and second insulating layers of the touch sensor are disposed facing each other so as to create the matrix network of conductive tracks.

A row/column array of conductive tracks is thus obtained, making it possible, through detection of a variation in impedance (resistance, capacitance) at the location of each crossing zone of conductive tracks, to detect the presence of an object (stylus, user's finger) on the touch sensor, opposite that crossing zone.

The touch sensor also comprises a network of conductive tracks extending between the rows and the columns of the matrix network, and an interface connector adapted to communicate with a control system of the touch sensor, in order to manage its operation and exploit the data acquired, and in particular the electrical signals sent.

This network of conductive tracks is adapted for the transfer of electrical signals between the rows and columns and the interface connector. It takes up a large amount of space in the touch sensor which is all the larger if the number of columns and rows in the matrix network is large.

These conductive tracks also give rise to an increase in the cost of the sensor since they require a high number of I/Os (I/O standing for Input/Output) at the interface connector.

By way of purely illustrative example, a touch sensor adapted for writing, with an accuracy of 250 DPI (DPI standing for Dots Per Inch), having a touch detection zone with a diagonal of 25 cm, comprises 2000 rows and 1500 columns approximately.

It is thus necessary to provide 3500 conductive tracks linking each row and each column to an input/output port of the interface connector.

The present invention is directed to simplifying the production of such a touch sensor, and in particular to reducing the number of conductive tracks necessary for the operation and exploitation of the data acquired by the touch sensor.

To that end, the present invention concerns a touch sensor comprising a touch detection zone comprising a matrix network of conductive tracks constituting columns on a first insulating layer and rows on a second insulating layer, the first and second insulating layers being disposed facing each other, and a network of conductive tracks adapted for the transfer of electrical signals between the rows and columns of the matrix network and an interface connector for interfacing with a control system of the touch sensor.

According to the invention, the touch sensor comprises control circuits respectively associated with the rows and columns of the matrix network of conductive tracks, the network of conductive tracks extending between the control circuits and the interface connector.

Thus, by direct integration into the touch sensor of control circuits (also called drivers) adapted to directly manage the operation of each row and column of the matrix network, it is possible to reduce the number of conductive tracks necessary to manage the overall operation of the touch sensor.

According to an advantageous feature of the invention, the network of conductive tracks comprises a subset of conductive tracks adapted to transfer a binary addressing signal to the control circuits.

Thus, the control circuits are controlled by means of a binary addressing signal. A limited number of conductive tracks makes it possible to address such a binary addressing signal to a high number of rows and columns of the matrix network.

In a practical embodiment of the touch sensor, each control circuit is adapted, on receiving a predetermined binary addressing signal, to supply electrical voltage to a column of the matrix network, and respectively to a row of the matrix network, the other columns, and respectively the other rows, being set to high impedance.

Simultaneously, each control circuit is adapted, on receiving a predetermined binary addressing signal, to send an electrical signal from a row of the matrix network, and respectively from a column of the matrix network, the other rows, and respectively the other columns, being grounded.

It is thus possible to control the independent operation of each row and each column of the matrix network in order to carry out the detection of one or more points of pressure on the touch sensor by virtue of the variation in the characteristics of an electrical signal.

In practice, a unique binary addressing signal is associated with each row and a unique binary addressing signal is associated with each column of the matrix network.

According to an advantageous feature of the invention, sequential scanning of the rows and columns of the matrix network of conductive tracks is employed, the subset of conductive tracks being adapted to sequentially transfer the set of unique binary addressing signals respectively associated with the rows and with the columns.

In practice, the control circuits are produced on the first and second insulating layers of the touch sensor.

Thus, these control circuits may be produced on each insulating layer of the touch sensor, for example by printing of a conductive ink or etching of a conductive layer, when producing the network of conductive tracks and the matrix network of rows and columns of the touch detection zone on each insulating layer.

According to a second aspect, the present invention also concerns a touch-control screen, comprising a touch sensor as described above and a display screen which are superposed.

This touch-control screen has features and advantages which are similar to those described above in relation to the touch sensor.

Still other particularities and advantages of the invention will appear in the following description.

In the accompanying drawings, given by way of non-limiting example:

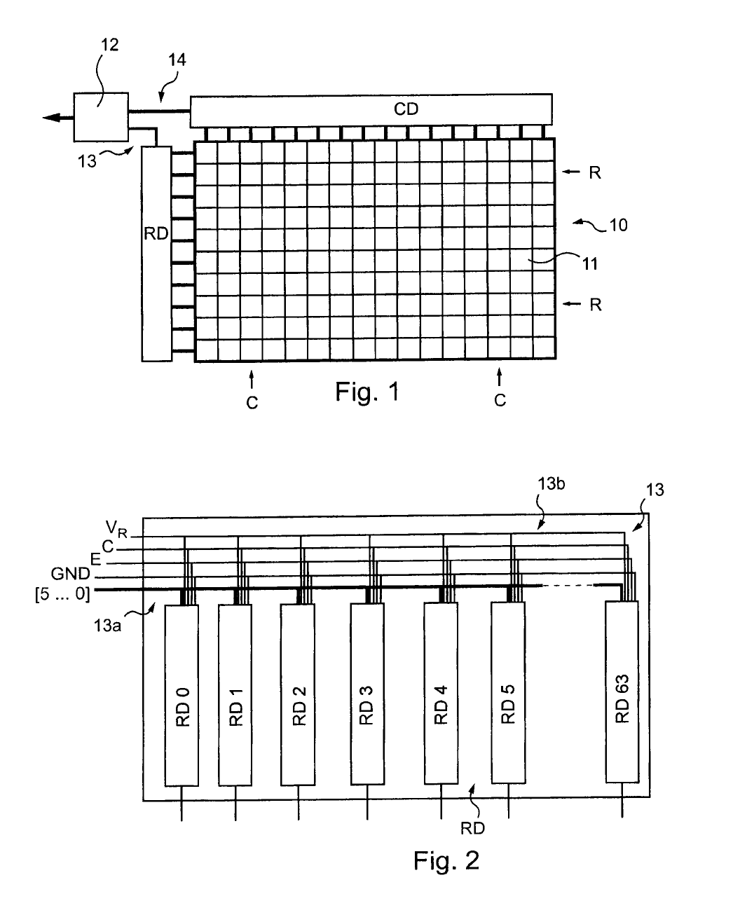

FIG. 1 is a diagram illustrating a touch sensor according to an embodiment of the invention;

FIG. 2 is a diagram illustrating control circuits for the rows of the touch sensor illustrated in FIG. 1;

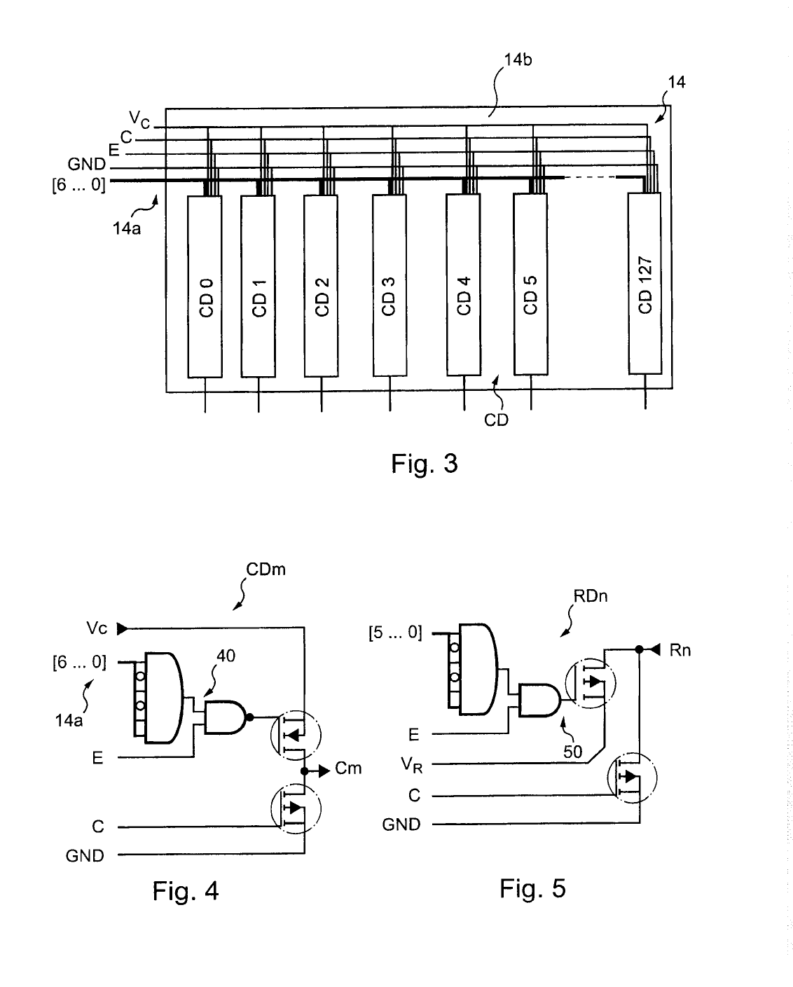

FIG. 3 is a diagram illustrating control circuits for the columns of the touch sensor illustrated in FIG. 1;

FIG. 4 is an electronic diagram illustrating an example embodiment of a control circuit for a column; and

FIG. 5 is an electronic diagram illustrating an example embodiment of a control circuit for a row.

A description will first of all be made with reference to FIG. 1 of a touch sensor 10 according to an embodiment of the invention.

Such a touch sensor 10 comprises a touch detection zone 11. This touch detection zone is preferably what is referred to as a multi-contact detection zone, that is to say adapted to simultaneously detect several points of pressing or of pressure applied to the surface of the touch sensor 10 on that touch detection zone.

In FIG. 1 there is diagrammatically illustrated a matrix network of conductive tracks thus forming rows and columns in the touch detection zone 11.

According to an orientation convention as illustrated in FIG. 1, the rows R extend horizontally and the columns C extend vertically, perpendicularly to the rows R.

In known manner, the rows R are formed from a first series of parallel conductive tracks, formed on a first insulating layer, and the columns C are formed from a second series of parallel conductive tracks, formed on a second insulating layer of the touch sensor.

At the time of manufacture, these two insulating layers are disposed facing each other with a layer of air or an insulating material separating the two series of conductive tracks disposed perpendicularly to each other in the touch detection zone 10.

Reference can advantageously be made to the description of document EP 1 719 047 for a detailed description of such a touch sensor 10.

The matrix of rows and columns thus defines crossing points or zones at the location of which the detection of a variation in impedance, and for example of a resistance, enables the presence of an object opposite that crossing zone to be detected.

In order to manage the operation of this touch sensor, an interface connector 12 is also provided to enable that touch sensor 10 to be electrically connected to an external operating system, enabling the data acquired on the touch sensor 10 to be managed.

It is thus necessary to provide a network of conductive tracks 13, 14 in that touch sensor making it possible to electrically connect the touch detection zone 11 of the touch sensor 10 to the interface connector 12.

As will become apparent from the following description, this network of conductive tracks 13, 14 is limited here in the number of conductive tracks on account of the integration within the touch sensor of control circuits associated with each row R and columns C of the touch sensor 10.

More specifically, the touch sensor 10 comprises a set of control circuits RD (acronym for Row Driver) adapted to control the operation of the rows R and a set of control circuits CD (acronym for Column Driver) adapted to control the operation of the columns C.

Illustrated in more detail in FIG. 2 is an example of a set of control circuits RD associated with the rows R.

Thus, this set of control circuits RD comprises control circuits RDn respectively associated with each row Rn.

In this example embodiment, and in a manner that is in no way limiting, it is considered that the number of rows Rn of the touch sensor 10 is equal to 64.

Thus, in this particular example, the index n varies from 0 to 63.

In its principle, the operation of each control circuit RDn is controlled on the basis of an addressing signal, or key, enabling each control circuit RDn to be independently controlled from a particular address.

To that end, a binary addressing signal is addressed to all the control circuits RDn, that binary addressing signal varying over an interval corresponding to the particular addresses of each control circuit RDn.

In this particular example, in which the number n of rows Rn is equal to 64, a binary addressing signal may be transferred by means of a subset of conductive tracks 13a composed of six conductive tracks (this network of six conductive tracks thus making it possible to transfer in binary 2⁶ different values).

Each control circuit RDn is also supplied by a second subset of conductive tracks 13b adapted to transfer control signals taken into account or ignored by the different control circuits RDn depending in particular on the value of the binary addressing signal received at each instant.

In this embodiment, and in a manner that is in no way limiting, the second subset of conductive tracks 13b enables in particular the transfer of an electrical voltage signal VR, for example equal to 5 volts, for setting the different rows Rn to ground GND (GND standing for ground) or the transfer of control signals C and E the use of which will be described later with reference to FIGS. 4 and 5.

It should be noted that thanks to the association of the control circuits RDn with each row Rn, the number of conductive tracks 13a, 13b of the network of conductive tracks 13 is relatively low, and in this example is equal to 9.

This number is in any case very much less than the 64 conductive tracks required in the state of the art for connecting each row Rn to the interface connector 12.

In similar manner is illustrated a set of control circuits CD which is associated with the columns C of the matrix connector 10.

Thus, this set of control circuits CD comprises control circuits CDm respectively associated with each column Cm.

In this example embodiment, and in a manner that is in no way limiting, it is considered that the number of columns Cm of the touch sensor 10 is equal to 128.

Thus, in this particular example, the index m varies from 0 to 127.

As above, the operation of each control circuit CDm is controlled on the basis of an addressing signal, or key, enabling each control circuit CDm to be independently controlled from a particular address.

To that end, a binary addressing signal is addressed to all the control circuits CDm, that binary addressing signal varying over an interval corresponding to the particular addresses of each control circuit CDm.

In this particular example, in which the number m of columns Cm is equal to 128, a binary addressing signal may be transferred by means of a subset of conductive tracks 14a composed of seven conductive tracks (this network of seven conductive tracks thus making it possible to transfer in binary 2⁷ different values.

Each control circuit CDm is also supplied by a second subset of conductive tracks 14b adapted, as previously, to transfer control signals taken into account or ignored by the different control circuits CDm depending in particular on the value of the binary addressing signal received at each instant.

In this embodiment, and in a manner that is in no way limiting, the second subset of conductive tracks 14b enables in particular the transfer of an electrical voltage signal VC, for example equal to 5 volts, for setting the different columns Cm to ground GND or the transfer of control signals C and E the use of which will be described later.

As previously, it should be noted that thanks to the association of the control circuits CDm with each column Cm, the number of conductive tracks 14a, 13b of the network of conductive tracks 14 is relatively low, and in this example is equal to 10.

This number is in any case very much less than the 128 conductive tracks required in the state of the art for connecting each column Cm to the interface connector 12.

All the control circuits CDm associated with the columns Cm and all the control circuits RDn associated with the rows Rn make it possible, on scanning the rows Rn and the columns Cm of the matrix network of the touch sensor 10, to control the supply in electrical voltage of each column (or each row), and to control the measurement of an electrical parameter on each row (or on each column).

In this embodiment it is considered, purely by way of illustration, that the control circuits CDm associated with each column Cm control the electrical voltage supply of each column Cm on scanning the matrix network, whereas the control circuits RDn associated with the rows Rn control the sequential measurement of an electrical signal on each row Rn.

Of course, the scanning could be the inverse, the rows being supplied with current and the electrical signals being read on each column.

In an embodiment, the sequential scanning may furthermore be periodically alternated.

Such an alternating sequential scanning method is in particular described in the document FR 2 925 715.

In practice, to perform this sequential scanning, the first control circuit CD0 supplies voltage to the first column C0 while the other control circuits CDm set the other columns Cm to high impedance; the first control circuit RD0 is then adapted to send the electrical signal coming from the first row R0, the other control circuits RDn being adapted to ground the other rows Rn.

Next the first control circuit RD0 grounds the first row R0 and the second control circuit RD1 is adapted to send the electrical signal coming from the second row R1, and so forth until all the rows Rn have been scanned.

Next, the first control circuit CD0 sets the first column C0 to high impedance and the second control circuit CD1 is in turn authorized to supply voltage to the second column C1 and the sequential scanning of the rows Rn is then carried out as described above.

The sequential scanning is thus carried out on all the columns Cm.

A description will be given with reference to FIG. 4 of an electronic circuit employed in a control circuit CDm associated with the supply of a column Cm.

The control circuit CDm is constituted by a logic gate 40 of the AND type which acts as a key.

Thus, when the addressing signal sent by the first subset of conductive tracks 14a corresponds to the address of the column Cm, the control circuit CDm is adapted to allow passage of the voltage signal Vc (for example equal to 5 V) according to the signal E (for Enable) in the associated column Cm.

The signals C (standing for Clear) and for ground GND enable the grounding of the columns Cm to be controlled when they are not supplied by the voltage signal Vc.

In similar manner, a control circuit RDn associated with a row Rn is illustrated in FIG. 5.

The control circuit RDn is constituted by a logic gate 50 of the AND type which acts as a key. The logic gate 50 is adapted to allow an electrical signal Vr to pass according to the signal E supplying the logic gate 50.

Thus, when the addressing signal sent by the first subset of conductive tracks 13a corresponds to the address of the row Rn, the control circuit RDn is adapted to allow passage of the electrical signal Vr coming from the row Rn, that is to say an electrical signal the characteristics of which depend on the impedance at the crossing point of that row Rn with a column Cm supplied at the same instant.

The electrical signal Vr is then sent via the interface connector 12 to the control system adapted to exploit the electrical signals sent by the touch sensor 10 to detect the zones of touch or pressing.

The signals C and for ground GND enable the grounding of the other rows Rn when they are not authorized to send the electrical signal Vr.

Thus, the integration into the touch sensor 10 of control circuits associated with each row and column of the matrix network makes it possible to limit the number of conductive tracks required for the operation of that touch sensor, and in particular the sequential scanning of the rows and columns of the matrix network.

This type of control circuit is particularly well adapted for high definition touch sensors, comprising a high number of rows and columns.

Thus, when the touch sensor comprises for example 2000 rows and 1500 columns, the address of each control circuit associated with each row may be defined by a binary signal sent by eleven conductive tracks and the address of each control circuit associated with each column may be defined by a binary signal sent by eleven conductive tracks.

Continuing with the above example in which eight control signals are sent for the operation of the control circuits CDm, RDn, a network of thirty conductive tracks makes possible the overall operation of the touch sensor provided with 2000 rows and 1500 columns.

This small number is to be compared with the number of 3500 conductive tracks necessary in the state of the art to manage the independent operation of the 2000 rows and 1500 columns.

Of course, the present invention is not limited to the description examples given above.

1-8. (canceled)

9. A touch sensor comprising:
a touch detection zone comprising a matrix network of conductive tracks constituting columns on a first insulating layer and rows on a second insulating layer, the first and second insulating layers being disposed facing each other, and a network of conductive tracks configured to transfer electrical signals between the rows and columns of the matrix network and an interface connector for interfacing with a control system of the touch sensor; and
control circuits respectively associated with the rows and columns of the matrix network of conductive tracks, the network of conductive tracks extending between the control circuits and the interface connector.

10. A touch sensor according to claim 9, wherein the network of conductive tracks comprises a subset of conductive tracks configured to transfer a binary addressing signal to the control circuits.

11. A touch sensor according to claim 10, wherein each control circuit is configured, on receiving a predetermined binary addressing signal, to supply electrical voltage to a column of the matrix network, and respectively to a row of the matrix network, other columns, and respectively other rows, being set to high impedance.

12. A touch sensor according to claim 10, wherein each control circuit is configured, on receiving a predetermined binary addressing signal, to send an electrical signal from a row of the matrix network, and respectively from a column of the matrix network, other rows, and respectively other columns, being grounded.

13. A touch sensor according to claim 10, wherein a unique binary addressing signal is associated with each row and a unique binary addressing signal is associated with each column of the matrix network.

14. A touch sensor according to claim 13, wherein sequential scanning of the rows and columns of the matrix network of conductive tracks is employed, the subset of conductive tracks being configured to sequentially transfer the set of unique binary addressing signals respectively associated with the rows and with the columns.

15. A touch sensor according to claim 9, wherein the control circuits are produced on the first and second insulating layers of the touch sensor.

16. A touch-control screen, comprising a touch sensor in accordance with claim 9 and a display screen which are juxtaposed.
